(19) United States
(12) Patent Application Publication
(10) Pub. No.: US 2022/0100161 A1
(43) Pub. Date: Mar. 31, 2022

(54) SYSTEM FOR CONTROLLING DEVICES OF A RESTAURANT OR CONVENIENCE STORE

(71) Applicants: Daniel PEREZ GONZALEZ, BOADILLA DEL MONTE (ES); Ana Belen PEREZ GONZALEZ, BOADILLA DEL MONTE (ES)

(72) Inventors: Daniel PEREZ GONZALEZ, BOADILLA DEL MONTE (ES); Ana Belen PEREZ GONZALEZ, BOADILLA DEL MONTE (ES)

(21) Appl. No.: 17/421,025

(22) PCT Filed: Jan. 10, 2019
(86) PCT No.: PCT/ES2019/070012

§ 371 Date: Jul. 7, 2021

(51) Int. Cl. G05B 19/05; G05B 15/02

(52) U.S. Cl. CPC G05B 19/058; G05B 19/054; G05B 15/02

(57) ABSTRACT

System (1) for monitoring the equipment of a restaurant (6) or convenience store (7) including:
sensors (50, 51, 52, 53, 54, 55, 56, 57, 58, 59, 60, 63, 64, 65) for various parameters located in at least one piece of equipment (20, 21, 22, 23, 24, 25) of the restaurant (6) or convenience store (7),
a control unit (11) located in the restaurant (6) or convenience store (7) and linked to the sensors (50, 51, 52, 53, 54, 55, 56, 57, 58, 59, 60, 63, 64, 65),
at least a first link (12) for internet access (18) associated with the control unit (11) for the exchange of commands and data,
at least one user terminal (13) provided with a second link (14) to the internet (18) for the exchange of commands and data with the control unit (11).

### OBJECT OF THE INVENTION

This invention refers to a system for monitoring equipment in a restaurant (or similar: bar, cafeteria or any establishment serving food or drink) or convenience store.

### BACKGROUND OF THE INVENTION

At present, the maintenance and attention to breakdowns of a restaurant or convenience store's industrial equipment requires travel, urgent in most cases, since these are customer service establishments or ones which keep perishable goods, and which are not infrequently caused by failures that can be easily resolved, even without technical personnel, which are not being attended to as quickly as they could be due to the absence of the technician or their delay in responding to the call, and which involve high travel costs and time costs because of the call-out, itself often of very little significance.

This drawback is solved with the use of the invention's system.

### DESCRIPTION OF THE INVENTION

The equipment monitoring system for a restaurant or convenience store has a configuration that allows a quick diagnosis of typical and minor failures in this equipment, which can be resolved by anyone present following simple instructions.

According to the invention, the system includes:
sensors for various parameters located in at least one piece of equipment in the restaurant or convenience store,
a control unit located in the restaurant or convenience store and linked to the sensors,
at least a first internet access link associated with the control unit for command and data exchange,
at least one user terminal provided with a second Internet link for command and data exchange with the control unit through the first link over the Internet.

This way, the sensors detect typical operating events, and any anomaly in them, and the control unit allows them to be read remotely and transmitted through the internet links, and thanks to this allows all these operating parameters of the equipment to be viewed and the anomaly to be detected from any terminal located anywhere in the world, allowing it to be resolved immediately by means of a communication, even without the presence of a technician, even allowing the equipment to be controlled or automated remotely, through the corresponding software.

But the system also allows remote analysis of the operation of the restaurant or convenience store equipment and is able to achieve energy savings from the results of that analysis, together with the reduction of costs that the reduction of the number of work orders for in-person resolution of breakdowns produces.

### BRIEF DESCRIPTION OF THE DRAWINGS

FIG. 1 shows a schematic view of the system of the invention.

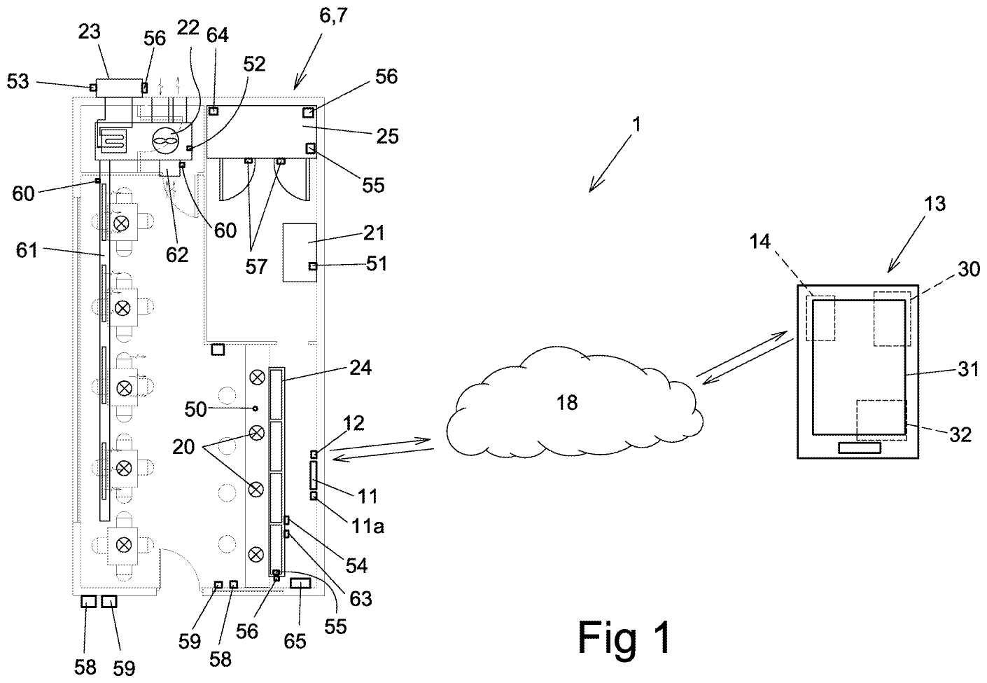

### DESCRIPTION OF A PRACTICAL EMBODIMENT OF THE INVENTION

The system (1) of the invention for monitoring the equipment of a restaurant (6) or convenience store (7) includes:
sensors (50, 51, 52, 53, 54, 55, 56, 57, 58, 59, 60, 63, 64, 65) for various parameters located in at least one piece of equipment (20, 21, 22, 23, 24, 25) of the restaurant (6) or convenience store (7),
a control unit (11) located in the restaurant (6) or convenience store (7) and linked to the sensors (50, 51, 52, 53, 54, 55, 56, 57, 58, 59, 60, 63, 64, 65),
at least a first link (12) for internet access (18) associated with the control unit (11) for the exchange of commands and data,
at least one user terminal (13) provided with a second link (14) to the internet (18) for the exchange of commands and data with the control unit (11) through the first link (12) over the internet (18).

Preferably, the control unit (11) includes at least a first recorder (11a) for data from the sensors (50, 51, 52, 53, 54, 55, 56, 57, 58, 59, 60, 63, 64, 65) for later retrieval if there is no live connection.

The first data recorder (11) includes at least one data logger since the data can then be stored autonomously.

For its part, the user terminal (13) ideally includes a second data recorder (30) to store the data and commands from the sensor readings and from the operational management for analysis immediately or later. Furthermore, it is preferred that the user terminal (13) includes a screen (31) associated with a graphics manager (32) to display the data and commands from the sensor readings and from the operational management as diagrams, to have an analysis capacity based on these graphs.

As for the sensors, they can be, for example:
first sensors (50) to monitor lighting (20) switching on and off,
second sensors (51) to monitor the extractor hood (21) switching on and off,
third sensors (52) to monitor ventilation (22) switching on and off,
fourth sensors (53) to monitor air conditioning equipment (23) switching on and off (air conditioning and heating),
fifth sensors (54) to monitor refrigeration equipment (24) switching on and off,
sixth sensors (55) to monitor defrosting switching on and off in refrigeration equipment (24) and cold stores (25),
seventh sensors (56) to monitor the setpoint of air conditioning equipment (23), refrigeration equipment (24) and cold stores (25),
eighth sensors (57) to monitor the opening of the cold store door (25),
ninth sensors (58) to monitor temperature and tenth sensors (59) to monitor humidity, inside and outside the restaurant (6) or convenience store (7), (necessary for air conditioning in some systems)
eleventh sensors (60) to monitor the air supply (61) and return (62) temperature in the air conditioning equipment (23),
twelfth sensors (63) to monitor temperature in the refrigeration equipment (24),
thirteenth sensors (64) to monitor the temperature in the cold stores (25),
fourteenth sensors (65) to monitor electricity consumption in real time in all the equipment (refrigeration (24), air conditioning (23), cold rooms (25), lighting (20), etc.).

In addition, timers, not shown, can be used, associated with one or more of the switching on and off monitoring sensors (50, 51, 52, 53, 54, 55) to be able to schedule their switching on and off.

Having sufficiently described the nature of the invention, as well as the way in which it is implemented in practice, it should be noted that the provisions indicated above and represented in the attached drawings may be subject to detailed modifications as long as they do not alter the fundamental principle.

1. System for monitoring the equipment of a restaurant or convenience store characterised by including:
sensors for various parameters located in at least one piece of equipment of the restaurant or convenience store,
a control unit located in the restaurant or convenience store and linked to the sensors,
at least a first link for internet access associated with the control unit for the exchange of commands and data,
at least one user terminal provided with a second link to the internet for the exchange of commands and data with the control unit through the internet and the first link.

2. System for monitoring equipment in a restaurant or convenience store according to claim 1 characterised by the control unit including at least a first recorder of data from the sensors.

3. System for monitoring equipment in a restaurant or convenience store according to claim 2 characterised by the first data recorder including at least one data logger.

4. System for monitoring equipment in a restaurant or convenience store according to claim 1 characterised by the user terminal including a second data recorder for storing the data and commands from the readings of the sensors and operational management.

5. System for monitoring equipment in a restaurant or convenience store according to claim 1 characterised by the user terminal including a screen associated with a graphic manager.

6. System for monitoring equipment in a restaurant or convenience store according to claim 1 characterised by the sensors being selected from:
first sensors to monitor lighting switching on and off,
second sensors to monitor the extractor hood switching on and off,
third sensors to monitor ventilation switching on and off,
fourth sensors to monitor air conditioning equipment switching on and off,
fifth sensors to monitor refrigeration equipment switching on and off,
sixth sensors to monitor defrosting switching on and off in refrigeration equipment and cold stores,
seventh sensors to monitor the setpoint of air conditioning equipment, refrigeration equipment and cold stores,
eighth sensors to monitor the opening of the cold store door,
ninth sensors to monitor temperature and tenth sensors to monitor humidity, inside and outside the restaurant or convenience store,
eleventh sensors to monitor the air supply and return temperature in the air conditioning equipment,
twelfth sensors to monitor temperature in the refrigeration equipment,
thirteenth sensors to monitor the temperature in the cold stores,
fourteenth sensors to monitor electricity consumption in real time in all the equipment (refrigeration (24), air conditioning (23), cold rooms (25), lighting (20), etc.).

7. System for monitoring equipment in a restaurant or convenience store according to claim 6 characterised by it including timers associated with one or more of the switching on and off monitoring sensors.
